(19) United States
(12) Patent Application Publication
(10) Pub. No.: US 2009/0326686 A1
(43) Pub. Date: Dec. 31, 2009

(54) PARAMETER SETTING DEVICE FOR MOTOR DRIVER

(75) Inventor: JUN-JONG CHANG, Tu-Cheng (TW)

Correspondence Address: PCE INDUSTRY, INC.;ATT. Steven Reiss, 288 SOUTH MAYO AVENUE, CITY OF INDUSTRY, CA, 91789, US

(73) Assignee: FOXNUM TECHNOLOGY CO., LTD., Tucheng City (TW)

(21) Appl. No.: 12/329,615

(22) Filed: Dec. 7, 2008

(30) Foreign Application Priority Data
Jun. 30, 2008 (CN) 200820301359.2

(51) Int. Cl. G05B 15/00

(52) U.S. Cl. 700/84; 700/83

(57) ABSTRACT

A parameter setting device includes a microprocessor, a command port, a display unit, an input unit, and a memory unit. The microprocessor electrically connects to the command port, the display unit, the input unit, and the memory unit.

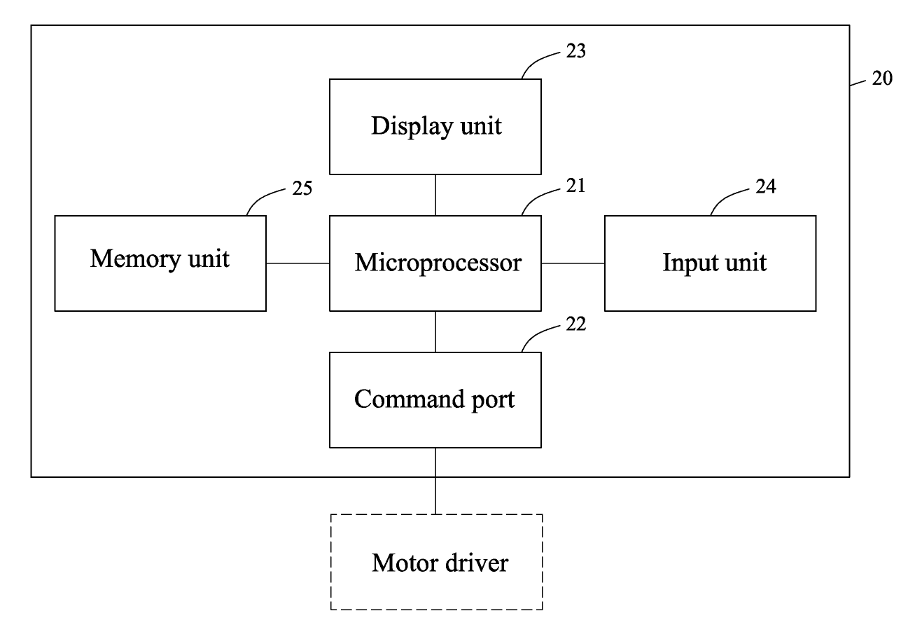

### BACKGROUND

1. Field of the Disclosure

The disclosure relates to motor drivers and, particularly, to a parameter setting device for motor drivers.

2. Description of Related Art

A computer or other controller manages servo motor operation via an interface which receives control commands and suitably applies on or off signals to switching circuitry. Generally, one servo motor utilizes one corresponding motor driver which has a microcomputer therein to interpret the control commands. The analog and digital (A/D) physical aspects of the motor driver, such as voltages, currents, rotational speed and others, as illustrated by oscilloscope, can monitor servo motor revolution and determine whether the servo motor is achieving predetermined tasks.

In application, however, the oscilloscope and the input key are only used for setting initial parameters for the servo motor for the initial run. After completing the initial parameter setting, the oscilloscope and the input key are never used later on in the operation. Furthermore, in large-scale environments, considerable time may be spent to individually set the parameters for a large number of motor drivers, all of which may be the same. Additionally, the motor drivers are often assembled on computer numerical control machines, making it inconvenient to make the adjustment.

What is needed, therefore, is a parameter setting device for motor drivers which reduces the volume of the motor driver and can be conveniently adjusted for multiple drivers.

### BRIEF DESCRIPTION OF THE DRAWINGS

Many aspects of the present parameter setting device for motor drivers can be better understood with reference to the following drawing. Components shown are not necessarily drawn to scale, the emphasis instead being placed upon clearly illustrating the principles of the present parameter setting device.

The FIGURE is a schematic block diagram of a parameter setting device in accordance with an embodiment of the present disclosure.

The exemplifications set out herein illustrate at least one embodiment of the present parameter setting device for motor driver, in one form, and such exemplifications are not to be construed as limiting the scope of the invention in any manner.

### DETAILED DESCRIPTION

Referring to the FIGURE, a parameter setting device 20 includes a microprocessor 21, a command port 22, a display unit 23, an input unit 24, and a memory unit 25. The microprocessor 21 electrically connects to the command port 22, the display unit 23, the input unit 24, and the memory unit 25.

A control command is input into the microprocessor 21 via the input unit 24, and stored in the memory unit 25. The command port 22 is connected to a motor driver (not labeled) and conveys the control command to the motor driver by serial transmission. The display unit 23 shows the revolution status of the servo motor.

In the present embodiment, the input unit 24 is a keyboard. Alternatively, the display unit 23 and the input unit 24 can be replaced with a touch panel providing Human-Computer Interaction capability. The command port 22 can be a RS232 serial transmission port, and the memory unit 25 can be a rewritable memory.

The display unit 23 and the input unit 24 in the device 20 can substitute for the display and the input unit installed on the motor driver. This configuration conforms to current industry trends toward smaller and lighter device profiles.

The memory unit 25 of the parameter setting device 20 stores the control commands, which can then be conveyed to a number of motor drivers having the same operating requirements, reducing adjustment time and process.

While the invention has been described by way of example and in terms of preferred embodiment, it is to be understood that the invention is not limited thereto. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A parameter setting device for motor drivers comprising a microprocessor, a command port, a display unit, an input unit, and a memory unit, wherein the microprocessor electrically connects to the command port, the display unit, the input unit, and the memory unit.

2. The parameter setting device as claimed in claim 1, wherein the input unit is capable of inputting a control command to the microprocessor, and the control command is stored in the memory unit.

3. The parameter setting device as claimed in claim 1, wherein the command port is connected to a motor driver, to which it conveys the control command.

4. The parameter setting device as claimed in claim 3, wherein the command port is a serial transmission port.

5. The parameter setting device as claimed in claim 1, wherein the display unit and the input unit are incorporated in a touch panel.

6. The parameter setting device as claimed in claim 2, wherein the input unit is a keyboard.

7. The parameter setting device as claimed in claim 1, wherein the memory unit is a rewritable memory.
